(19) United States
(12) Patent Application Publication
(10) Pub. No.: US 2021/0086038 A1
(43) Pub. Date: Mar. 25, 2021

(54) SPORTS TRAINING BALL

(71) Applicants: Andrew RYAN, Buffalo, NY (US); Eric SAENGER, Clarence, NY (US)

(72) Inventors: Andrew RYAN, Buffalo, NY (US); Eric SAENGER, Clarence, NY (US)

(21) Appl. No.: 17/025,507

(22) Filed: Sep. 18, 2020

Related U.S. Application Data
(60) Provisional application No. 62/902,983, filed on Sep. 20, 2019.

(51) Int. Cl. A63B 43/00; A63B 41/02; A63B 41/08; B29D 22/02

(52) U.S. Cl. CPC A63B 43/002; B29D 22/02; A63B 41/08; A63B 41/02

(57) ABSTRACT

A sports ball comprising a transparent outer wall surrounding a hollow cavity and defining a geometric center, and a central core object suspended at the geometric center of the hollow cavity. The ball may have the shape of a sphere having a center point, with the central core object suspended at the center point of the sphere. In other cases, the ball may be oblong or ellipsoid, with the central core object suspended at the center points of the respective major and minor axes of the ellipsoid. The transparent outer wall of the ball may be elastically deformable, and may be comprised of a transparent inflatable bladder contiguous with an inner surface of a transparent outer skin. The transparent outer skin may be comprised of a plurality of outer facets joined together, such as by sewing.

### CROSS-REFERENCE TO RELATED PATENT APPLICATIONS

This application claims the benefit of U.S. Provisional Patent Application No. 62/902,983 filed Sep. 20, 2019, the disclosure of which is incorporated herein by reference. The above benefit claim is being made in an Application Data Sheet submitted herewith in accordance with 37 C.F.R. 1.76 (b)(5) and 37 C.F.R. 1.78.

### BACKGROUND

### Technical Field

Balls used in playing and training for sporting games, and in particular, balls that are struck or kicked by players of the games.

### Description of Related Art

Many sporting games are based on play with a ball. The ball may be spherical (e.g., golf, tennis, baseball, softball, soccer, volleyball), or oblong (e.g. rugby, American football). The ball may be joined to the top of a rod, or suspended under a horizontal plate; such a ball configuration is commonly known as a punching bag, and is used in training for boxing and other defensive arts. From levels of youths to adults, players are motivated to practice and improve their level of play. In all types of ball games, training to improve play involves repetitive drills based on imparting motion of the ball, whether it is by kicking, hand striking, or implement striking with a bat, club, racket or other implement of the sport

Typically in such sports, in all such sports, players ranging from young children through professional athletes are taught to “hit through the center of the ball,” or to “aim for the center of the ball” in their training exercises and during play. However, taking an action to hit through the ball or to “aim for its center is difficult, because in general, all sports balls are non-transparent objects, and thus the center of any given ball cannot be seen. For practice and training in any particular ball-based sport, what is needed is a ball having substantially the same properties as a regular ball of the sport, but having a transparent external skin and a visible center core.

### SUMMARY

Balls provided in accordance with the present disclosure meet this need. In a broad aspect, the balls are visualization tools having the form, size, feel and weight of the balls of the respective sports. They are comprised of a clear outer material and an opaque center approximately 5-25% the size of the standard ball exterior. The opaque “core” provides the player with a focal point upon which to concentrate attention as he/she hits, kicks or catches the ball in training exercises or general play.

In one aspect of the present disclosure, a sports ball is provided comprising a transparent outer wall surrounding a hollow cavity and defining a geometric center, and a central core object suspended at the geometric center of the hollow cavity. In certain cases, the ball may have the shape of a sphere having a center point, with the central core object suspended at the center point of the sphere. In other cases, the ball may be oblong or ellipsoid, with the central core object suspended at the center points of the respective major and minor axes of the ellipsoid. In a spherical ball, the ratio of the diameter of the ball to the diameter of the central core object is preferably between 2:1 and 20:1, depending upon the size of the ball and the needs in playing the particular sport. In certain cases, the transparent outer wall of the ball may be elastically deformable. In certain cases, the transparent outer wall of the ball may be comprised of a transparent inflatable bladder contiguous with an inner surface of a transparent outer skin. The transparent outer skin may be comprised of a plurality of outer facets joined together, such as by sewing.

In one version of the sports ball, the central core object may be suspended by a first elastic cord comprising a first end joined to the transparent outer wall, and a second end joined to the transparent outer wall and opposed to the first end. In another version, the central core object may be further suspended by a second elastic cord comprising a first end joined to the transparent outer wall, and a second end joined to the transparent outer wall and opposed to the first end, with the second elastic cord aligned orthogonal to the first elastic cord. In another version, the central core object may be further suspended by a third elastic cord comprising a first end joined to the transparent outer wall, and a second end joined to the transparent outer wall and opposed to the first end, with the third elastic cord aligned orthogonal to the first elastic cord and the second elastic cord.

In another version of the sports ball, the central core object may be suspended by a first elastic cord comprising a first end joined to the transparent outer wall, and a second end joined to the central core object, a second elastic cord comprising a first end joined to the transparent outer wall, and a second end joined to the central core object, a third elastic cord comprising a first end joined to the transparent outer wall, and a second end joined to the central core object, and a fourth elastic cord comprising a first end joined to the transparent outer wall, and a second end joined to the central core object. The first, second, third, and fourth elastic cords are operable to provide force vectors maintaining the central core object in position at the geometric center of the hollow cavity of the ball.

In another version of the sports ball, the central core object may be embedded at a center point of an elastic membrane joined to an interior surface of the transparent outer wall. The elastic membrane may bisect the hollow cavity of the ball into two equal volumes.

In another version of the sports ball, the ball is comprised of a transparent outer wall surrounding a hollow cavity and defining a geometric center, a transparent toroidal bladder contained within the transparent outer wall and having an outer wall portion contiguous with the transparent outer wall, and a central core object joined to a central wall portion of the transparent toroidal bladder, and suspended at the geometric center of the hollow cavity.

### BRIEF DESCRIPTION OF THE DRAWINGS

The present disclosure will be provided with reference to the following drawings, in which like numerals refer to like elements, and in which:

FIGS. 1-7 depict a sequence of steps for forming an inflatable bladder of a conventional hollow pressurized sports ball, such as a soccer ball, volleyball, or football;

FIGS. 8-9 depict a first apparatus and sequence of steps for forming an inflatable bladder of a hollow pressurized sports ball in accordance with the present disclosure;

FIG. 10 is a cross-sectional view of a bladder made using the apparatus and steps of FIGS. 8-9;

FIG. 11 is a perspective view of the bladder of FIG. 10 shown in a partially inflated state;

FIGS. 12-13 depict an alternative configuration of the first apparatus for making the bladder of FIGS. 10 and 11;

FIG. 14 is a perspective view of an apparatus for forming an alternative inflatable bladder of a hollow pressurized sports ball in accordance with the present disclosure;

FIG. 15 is a side elevation view of the apparatus of FIG. 14, taken along line 15-15 of FIG. 14;

FIG. 16 is a side cross-sectional view of the apparatus of FIG. 14, taken along line 16-16 of FIG. 14;

FIG. 17 is a perspective view of a bladder made using the apparatus of FIGS. 14-16;

FIG. 18 depicts a transparent sports ball of the present disclosure, including a bladder made using the apparatus and steps of FIGS. 8-9, or FIGS. 12-13;

FIG. 19 depicts a transparent sports ball of the present disclosure, including additional central core object suspension members;

FIG. 20 depicts an alternative transparent sports ball of the present disclosure;

FIG. 21 depicts another alternative transparent sports ball of the present disclosure; and

FIG. 22 depicts a ball similar to the alternative transparent ball of FIG. 21 in a cutaway view.

The present invention will be described in connection with certain preferred embodiments. However, it is to be understood that there is no intent to limit the invention to the embodiments described. On the contrary, the intent is to cover all alternatives, modifications, and equivalents as may be included within the spirit and scope of the invention as defined by the appended claims.

### DETAILED DESCRIPTION

For a general understanding of the present invention, reference is made to the drawings. In the drawings, like reference numerals have been used throughout to designate identical elements. The drawings are to be considered exemplary, and are for purposes of illustration only. The dimensions, positions, order and relative sizes reflected in the drawings attached hereto may vary, and the dimensions and positions of objects are not necessarily to scale, but instead are shown to clearly illustrate basic principles of the present invention.

In the following disclosure, certain components may be identified with the adjectives “top,” “upper,” “bottom,” “lower,” “left,” “right,” etc. These adjectives are provided in the context of the orientation of the drawings, which is arbitrary. The description is not to be construed as limiting the balls disclosed herein to use in a particular spatial orientation. The balls of the present disclosure may be used in orientations other than those shown in the drawings.

It is also to be understood that any connection references used herein (e.g., attached, coupled, connected, and joined) are to be construed broadly and may include intermediate members between a collection of elements and relative movement between elements unless otherwise indicated. As such, connection references do not necessarily imply that two elements are directly connected and in fixed relation to each other.

The term “providing”, such as for “providing a bladder” and the like, when recited in the claims, is not intended to require any particular delivery or receipt of the provided item. Rather, the term “providing” is merely used to recite items that will be referred to in subsequent elements of the claim(s), for purposes of clarity and ease of readability.

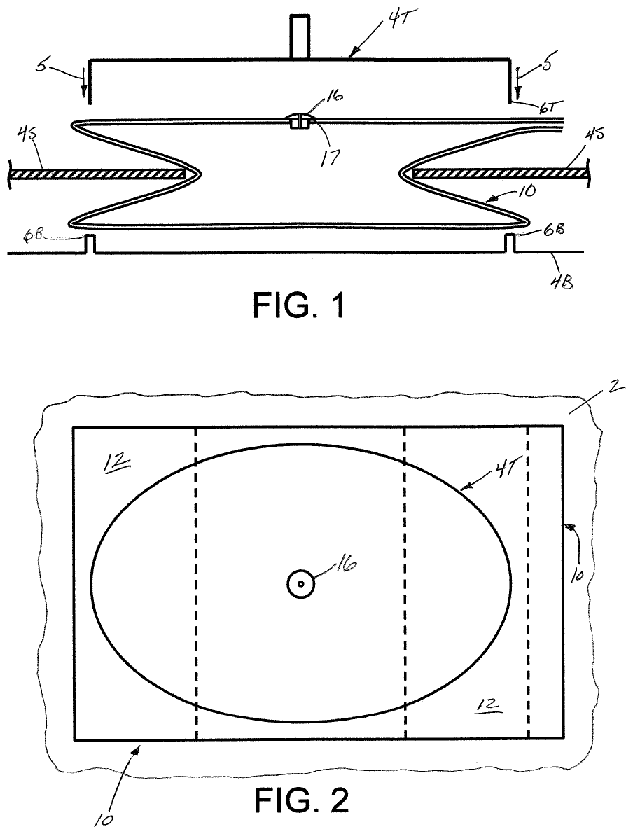

FIGS. 1-7 depict a sequence of steps for forming an inflatable bladder of a conventional hollow pressurized sports ball, such as a soccer ball, volleyball, or football. Such steps are disclosed in U.S. Pat. No. 8,727,920 of Sandusky, the disclosure of which is incorporated herein by reference. The steps are summarized here for the purpose of enabling a clearer understanding of the sports balls of the present disclosure, and the apparatus and methods for fabricating them.

Referring first to FIGS. 1 and 2, a sheet 10 of an elastomer is placed in a folded configuration and disposed on a supporting fixture 2. It is noted that in the folded configuration shown in FIG. 1, the folds are shown as widely spaced for clarity of illustration. The folded configuration may be more compact in the vertical direction than is shown in the drawings. A fill valve 16 may be fitted in a pre-cut hole 17 formed in the elastomer sheet.

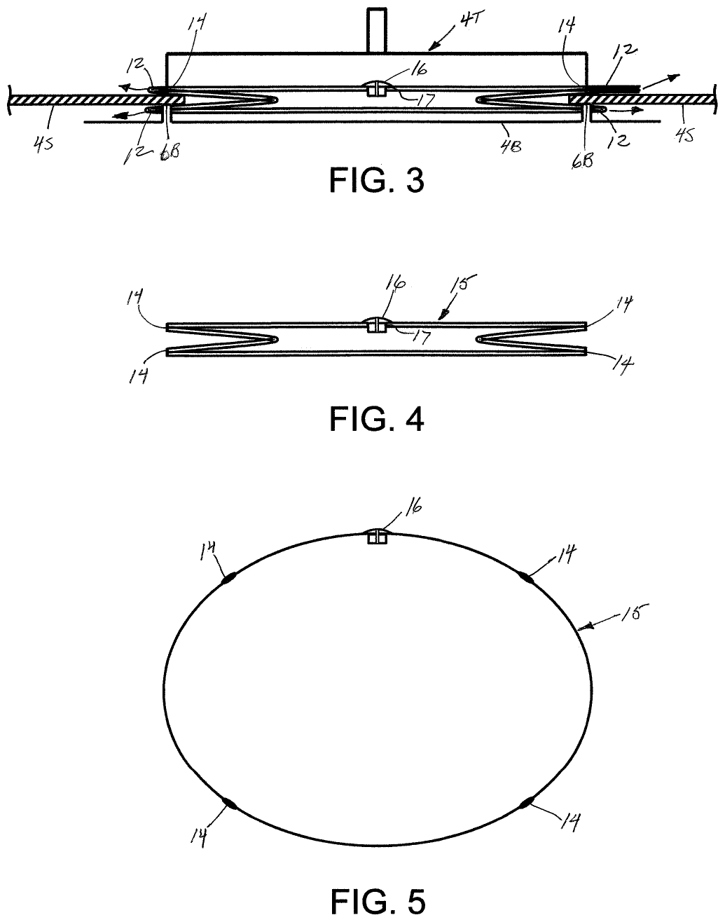

A top cutting die 4T comprising a cutting edge 6T is moved vertically toward the folded sheet 10 as indicated by arrows 5, and towards a mating cutting base 4B. A cutting spacer 4S is disposed between the folds of the folded sheet 10. Referring to FIG. 3, when the cutting edge 6T of cutting die 4T clamps down on the folded sheet 10 and cutting spacer 4S against the cutting ring 6B of the cutting base 4B, the cutting die 4T, cutting spacer 4S, and cutting base 4B coact to cut excess material 12 from the folded sheet 10. Additionally, the cutting die 4T, cutting spacer 4S, and cutting base 4B are heated, such that they melt the elastomer and/or cross-links the elastomer sheet 10 at the perimeter of the cutting edge 6T and cutting ring 6B, thereby fusing the folded layers together and forming sealed seams 14 in the cut folded sheet. Referring to FIG. 4, a die-cut bladder 15 is produced.

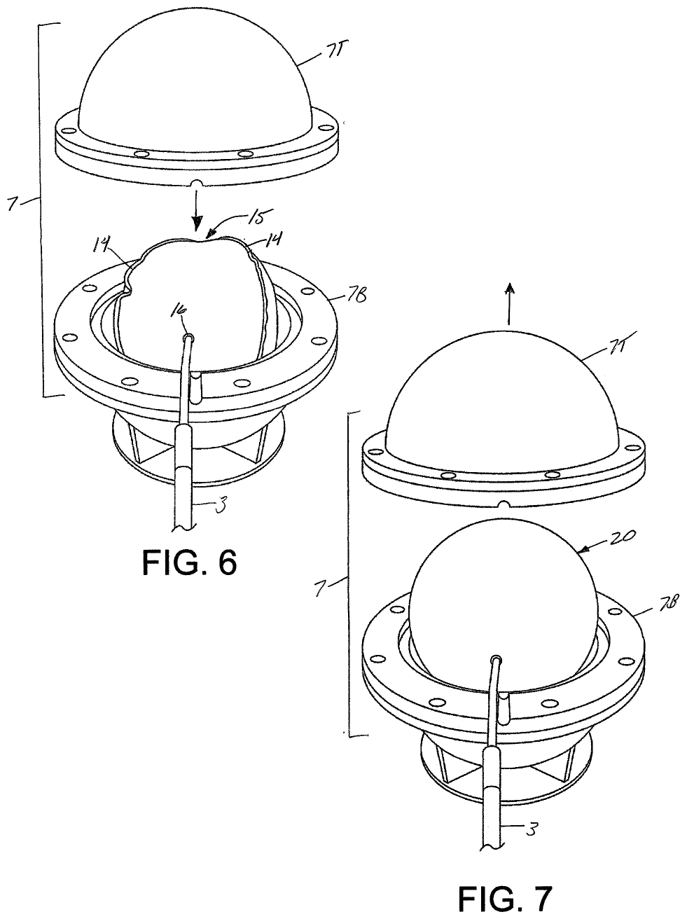

Referring to FIGS. 5 and 6, the die-cut bladder 15 may be inflated via a gas supply tube 3 connected to the valve 16. The inflated die-cut bladder 15 is placed in a vulcanizing fixture 7 comprised of a top half 7T and a bottom half 7B. The top half 7T is joined to the bottom half 7B form a spherical cavity containing the die cut bladder 15, which is further inflated so as to be contiguous with the spherical cavity wall. The vulcanizing fixture 7 is heated so as to cross-link the elastic sheet material of the die-cut bladder 15. Referring to FIG. 7, the top half 7T is separated from the bottom half 7B, and the finished bladder 20, vulcanized and cured into a permanent spherical shape, is removed from the vulcanizing fixture 7.

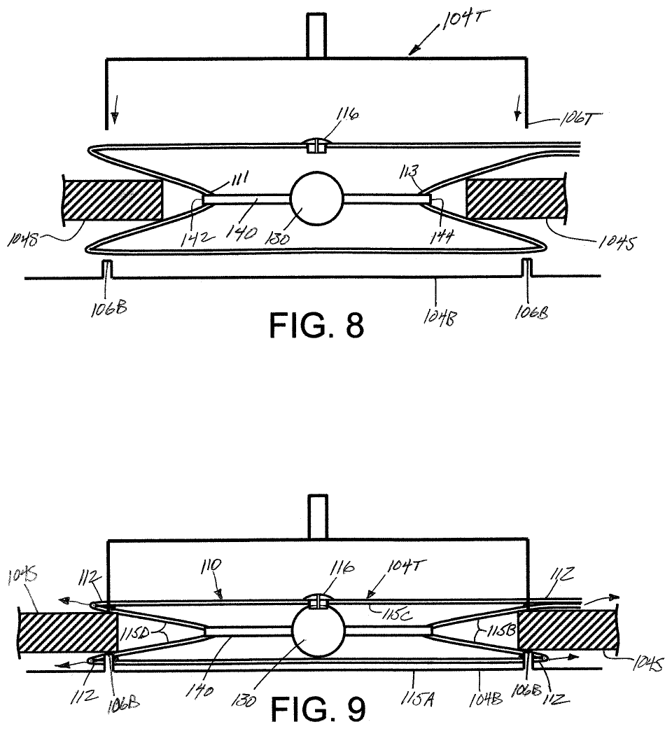

In one aspect of the present disclosure, the apparatus and steps shown in FIGS. 1-7 are modified to produce a sports ball comprising a transparent outer wall surrounding a hollow cavity and defining a geometric center, and a central core object suspended at the geometric center of the hollow cavity. Referring to FIG. 8, a sheet 110 of a transparent elastomer is placed in a folded configuration and disposed on a supporting fixture (not shown). Additionally, a central core object 130 is joined to an elastic cord 140, and the respective distal ends 142 and 144 of the cord 140 are disposed in holes formed at the folds 111 and 113 of the sheet 110. In certain cases, the distal ends 142 and 144 of the cord 140 may be joined to the folds 111 and 113 by a suitable adhesive and/or by heating and fusing the two materials. In other cases, the distal ends 142 and 144 of the cord 140 may be joined to the folds 111 and 113 during a cutting step and/or a vulcanizing step that follows.

Referring to FIG. 9, a cutting die 104T comprising a cutting edge 106T is moved vertically toward the folded sheet 110, and towards a mating cutting base 104B. A cutting spacer 104S is disposed between the folds of the folded sheet 10. When the cutting edge 106T of cutting die 104T clamps down on the folded sheet 10 and cutting spacer 104S against the cutting ring 106B of the cutting base 104B, the cutting die 104T, cutting spacer 104S, and cutting base 104B coact to cut excess material 112 from the folded sheet 110. Additionally, the cutting die 104T, cutting spacer 104S, and cutting base 104B are heated, such that they melt the elastomer and/or cross-links the elastomer sheet 110 at the perimeter of the cutting edge 106T and cutting ring 106B, thereby fusing the folded layers together and forming sealed seams in the cut folded sheet. During the cutting step, the distal ends 142 and 144 of the cord 140 may be joined to the folds 111 and 113 as described above. The supporting fixture 102 may be heated so as to provide thermal energy for joining the ends 142 and 144 of the cord 140 to the folds 111 and 113. Alternatively, the ends 142 and 144 of the cord 140 may be joined to the folds 111 and 113 using a photo-curable adhesive and a light source (not shown), such as an ultraviolet light. Alternatively, the ends 142 and 144 of the cord 140 may be joined to the folds 111 and 113 using a laser.

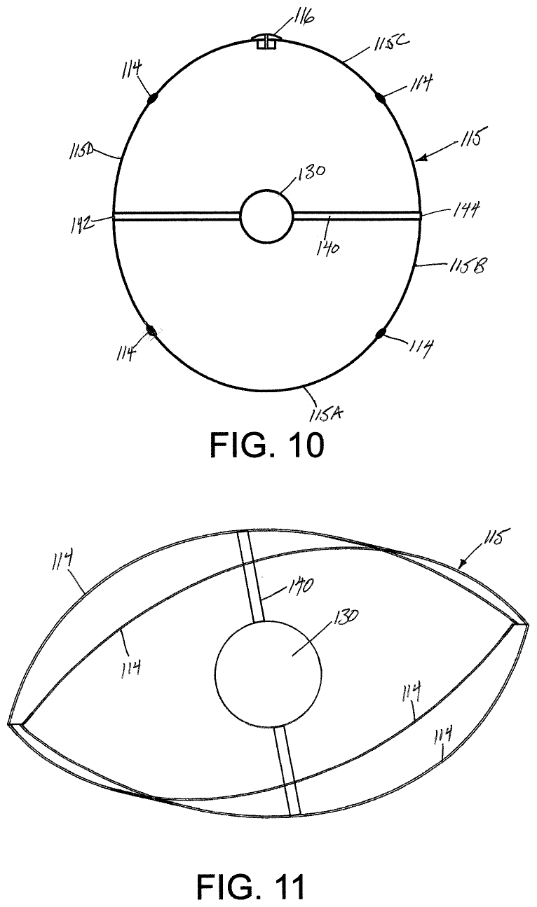

Referring to FIGS. 9 and 10, a die-cut bladder 115 is produced, comprised of die-cut wall sections 115A-115D joined at seams 114, and central core object 130 joined to an elastic cord 140. (It is noted that the relative distances between the seams 114 in the bladder 115 of FIG. 10 are not necessarily to scale with respect to the locations of the folds of the sheet 110 in FIGS. 8 and 9.) The die-cut bladder 115 may include a valve 116 and inflated as described previously for conventional bladder 15 of FIG. 5, resulting in the central core object 130 being suspended within the bladder 115. Subsequently, the partially inflated die-cut bladder 115 is placed within a vulcanizing fixture, fully inflated to a spherical shape, and vulcanized as described previously for conventional bladder 15 of FIGS. 6 and 7. Thus a finished transparent bladder is formed with transparent outer wall surrounding a hollow cavity and with the central core object 130 suspended at the geometric center of the hollow cavity.

After the finished transparent bladder is formed, it may then be covered with a transparent skin, which may be configured in a manner similar to a conventional ball of the particular sport for which the ball is being made. The transparent skin may be molded around the bladder, or formed by a film coating process. Alternatively, the transparent skin may be formed from individual transparent panels that are sewn together. For example, for a conventional soccer ball, the transparent skin may be made of an assembly of transparent panels comprising twelve pentagonal panels and twenty hexagonal panels joined by edge-to-edge sewing. A transparent skin of a conventional volleyball may be made of an assembly of eighteen rectangular panels joining by edge-to-edge sewing.

It is also to be understood that while the bladders and balls described above are spherical in shape, a bladder and ball of the present disclosure may be made with an oblong shape, such as for a rugby ball, or an American football. To make such oblong balls, the dies and vulcanizing fixtures are dimensioned as needed.

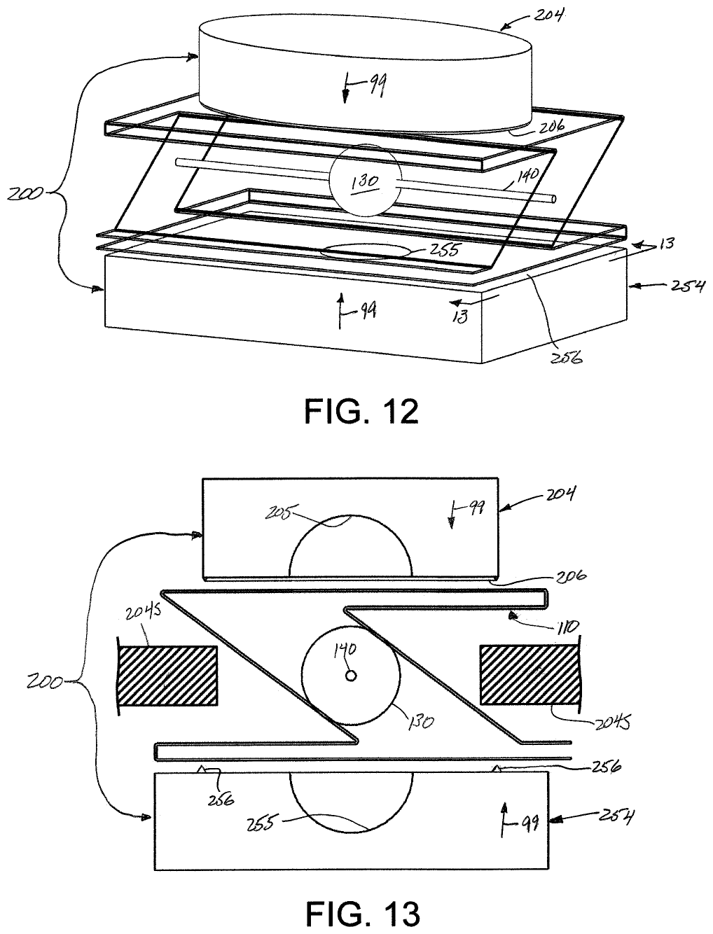

FIG. 12 is a perspective view of an alternative configuration of an apparatus for making the bladder of FIGS. 10 and 11, and FIG. 13 is a side elevation view of the apparatus 200, taken along line 13-13 of FIG. 12. Referring to FIGS. 12 and 13, the apparatus 200 is comprised of an upper die 204, a lower die 254, and an actuator (not shown) that is operable to move one or both of the upper die 204 and the lower die 254 toward and away from each other. The upper die 204 includes a hemispherical cavity 205, which is slightly larger in diameter than the spherical central core object 130, and a cutting edge 206. (It is to be understood that the central core object could have a shape other than spherical, and the cavity 205 would be slightly larger but dimensioned accordingly to match the shape of the central core object.) In like manner, the lower die 254 includes a hemispherical cavity 255, which is slightly larger in diameter than the spherical central core object 130, and which is opposed to the hemispherical cavity 205 of the upper die 204.

In forming a bladder of a ball of the present disclosure, a sheet 110 of transparent elastomer is folded and disposed between the upper die 204 and the lower die 254, with the central core object 130 and the elastic cord 140 contained within the folded sheet 110. (It is noted that an alternative folding pattern is shown in FIGS. 12 and 13, as compared to the folding pattern shown in FIGS. 8 and 9. Other folding patterns are contemplated, which will achieve the same result in forming the bladder.) With the folded bladder 110, central core object 130, and elastic cord 140 positioned between the upper and lower dies 204 and 254, and cutting spacers 204S disposed between the folds, one or both of the dies 204 and 254 are moved relative to each other by the actuator (not shown) as indicated by arrows 99.

As the upper and lower dies 204 and 254 are moved toward each other, portions of the folded sheet 110 and upper and lower halves of the central core object 130 are disposed in the respective upper and lower hemispherical cavities 205 and 255. The upper and lower dies 204 and 254 are moved toward each other until the cutting edge 206 of the upper die 204 is forced against the layers of folded sheet 110 and cutting spacers 204S, whereupon it cuts through them, and continues on until the cutting edge 256 of the lower die 254 contacts the cutting spacer 204 S. At least the upper die 204 and the lower die 254 (and optionally, the cutting spacer 204S) are heated such that the edges of the cut folded sheet are fused to form bladder seams as described previously. The upper and lower dies 204 and 254 may then be separated from each other by the actuator, and the die cut bladder removed from the dies 204 and 254. The resulting die cut bladder is substantially the same as the bladder 115 of FIGS. 8 and 9. The die cut bladder may then be placed in a vulcanizing fixture as shown in FIGS. 6 and 7, inflated to the shape of the cavity of the fixture, and vulcanized to form a finished bladder having a transparent outer wall, as described previously. If the transparent elastomeric material used to make the finished bladder is sufficiently thick and tough for use in play of the particular ball sport, then the finished bladder forms the transparent outer wall, and nothing further is required to provide a sports ball of the present disclosure.

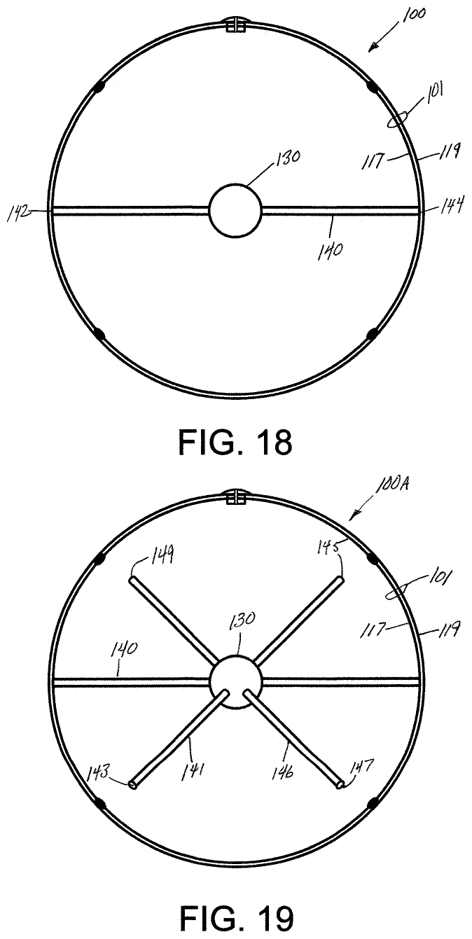

In other cases, the finished transparent bladder may then be disposed within a transparent outer skin as described previously. The combination of a finished transparent bladder and transparent skin made using the apparatus and methods of FIGS. 8-13 results in a sports ball 100 of the present disclosure as shown in FIG. 18. The transparent outer wall 101 is comprised of transparent inflatable bladder 117 contiguous with an inner surface of a transparent outer skin 119.

The transparent outer wall 101 surrounds a hollow cavity and defines a geometric center. The central core object 130 is suspended at the geometric center of the hollow cavity by the elastic cord 140. The ball 100 may have the shape of a sphere having a center point, with the central core object suspended at the center point of the sphere as shown in FIG. 18. In other cases (not shown), the ball may be oblong or ellipsoid, with the central core object suspended at the center points of the respective major and minor axes of the ellipsoid. In a spherical ball, the ratio of the diameter of the ball to the diameter of the central core object is preferably between 2:1 and 20:1, depending upon the size of the ball and the needs in playing the particular sport.

In the sports ball 100 as described above, the elastic cord 140 holds the center core object 130 at the geometric center of the ball when the ball is at rest. However, the center core object 130 may be displaced from its central position, either when the ball is struck or kicked in play, or when the ball is spinning or rolling. Referring to FIG. 19, an alternative sports ball 100A is shown, which may be made using the methods previously described. The central core object 130 may be further suspended by a second elastic cord 141 comprising a first end 143 joined to the transparent outer wall 101, and a second end 145 joined to the transparent outer wall 101 and opposed to the first end 143. The second elastic cord 141 may be aligned orthogonal to the first elastic cord 140. In a further case, the central core object 130 may be further suspended by a third elastic cord 146 comprising a first end 147 joined to the transparent outer wall 101, and a second end 149 joined to the transparent outer wall 101 and opposed to the first end 147. The third elastic cord 146 may be aligned orthogonal to the first elastic cord 140 and the second elastic cord 141. In yet another case (not shown), the central core object may be suspended by four or more elastic cords, which function to provide force vectors maintaining the central core object in position at the geometric center of the hollow cavity of the ball.

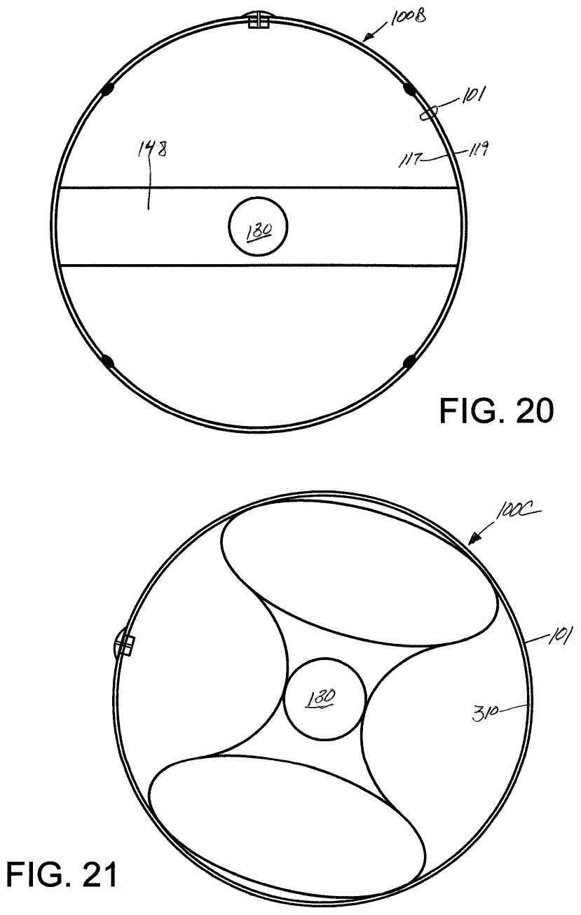

Referring to FIG. 20, an alternative sports ball 100B is shown, which may be made using the methods previously described. The central core object 130 of the ball 100B may be embedded at a center point of an elastic membrane 148 joined to an interior surface of the transparent outer wall 110. The elastic membrane 148 may bisect the hollow cavity of the ball 100B into two equal volumes.

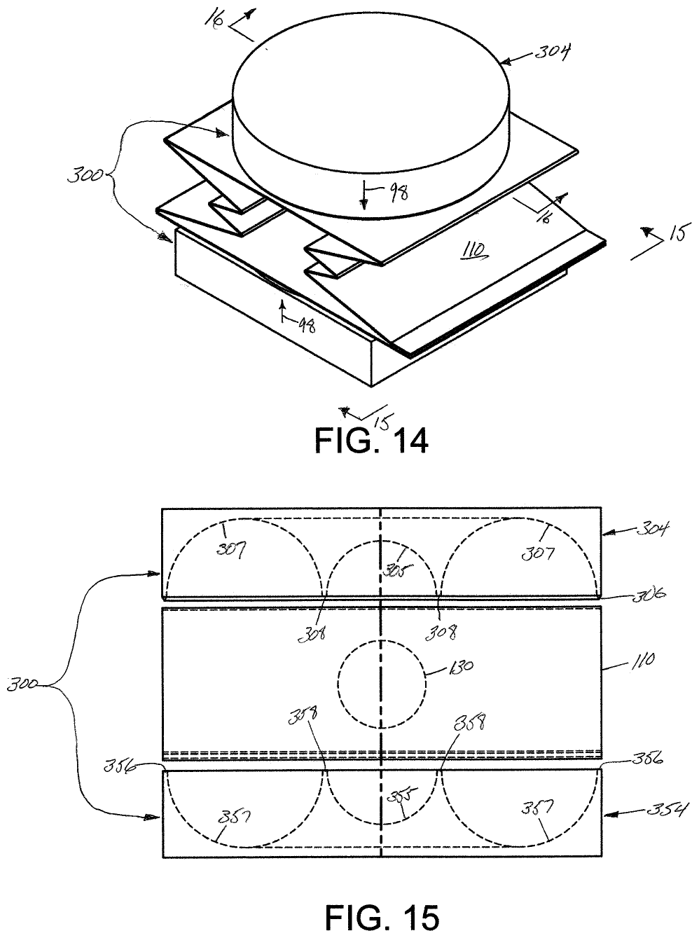

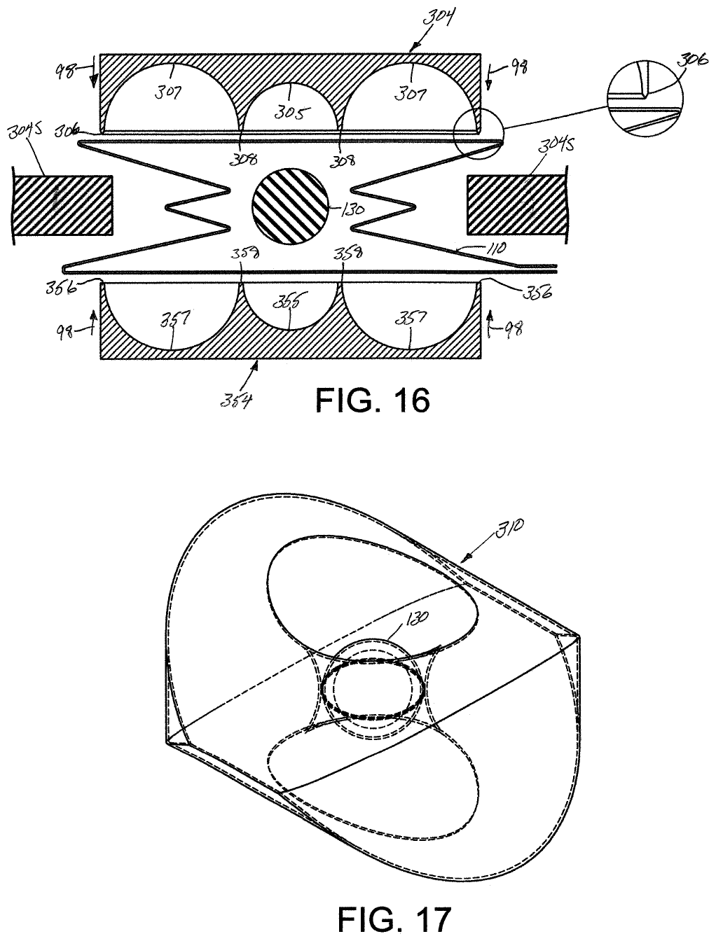

Another alternative sports ball 100C is shown in FIG. 21, comprising a transparent toroidal bladder 310 surrounding a central core object 130, contained within an outer skin 101. The sports ball 100C may be made using the apparatus 300 shown in FIGS. 14-16, which will now be described.

In some respects, apparatus 300 is similar to apparatus 200 shown in FIGS. 12-13 and described previously, comprising an upper die 304, a lower die 354, cutting spacers 304S, and an actuator (not shown) that is operable to move one or both of the upper die 304 and the lower die 354 toward and away from each other.

The upper die 304 includes a hemispherical cavity 305 slightly larger in diameter than the spherical central core object 130, and a cutting edge 306. The upper die 304 further includes a toroidal half-cavity 307, which surrounds the hemispherical cavity 305. The toroidal half-cavity 307 is bounded on its exterior by the cutting edge 306, and on its interior by an inner annular edge 308. In like manner, the lower die 354 includes a hemispherical cavity 355 slightly larger in diameter than the spherical central core object 130, and opposed to the hemispherical cavity 305 of the upper die 304. The lower die 354 further includes a toroidal half-cavity 357, which surrounds the hemispherical cavity 355 and is opposed to the toroidal half-cavity 307 of the upper die 304. The toroidal half-cavity 357 is bounded on its exterior by an outer annular edge 356, and on its interior by an inner annular edge 358.

In forming a bladder of a ball of the present disclosure, a sheet 110 of transparent elastomer is folded and disposed between the upper die 304 and the lower die 354, with the central core object 130 contained within the folded sheet 110 and the cutting spacers 304S disposed between the folds of the folded sheet 110. (The folding pattern may be as shown in FIGS. 14-17. Other folding patterns are contemplated, which will achieve the same result in forming the bladder.) With the folded bladder 110 and central core object 130 positioned between the upper and lower dies 304 and 354, one or both of the dies 304 and 354 are moved relative to each other by the actuator (not shown) as indicated by arrows 98.

As the upper and lower dies 304 and 354 are moved toward each other, portions of the folded sheet 110 and upper and lower halves of the central core object 130 are disposed in the respective upper and lower hemispherical cavities 305 and 355. The upper and lower dies 304 and 354 are moved toward each other until the cutting edge 306 of the upper die 304 is forced against the layers of folded sheet 110 and cutting spacers 304S, whereupon it cuts through them, and continues on until the cutting edge 306 of the upper die 304 and the cutting edge 356 of the lower die 354 contact the cutting spacers 304S. At least the upper die 304 and the lower die 354 (and optionally, the cutting spacer 304S) are heated, such that the edges of the folded sheet that are cut by the cutting edges 306 and 356 are fused to form an outer bladder seam in the same manner as described previously. Additionally, the inner annular edge 308 of the upper die 304 and the inner annular edge 358 of the lower die 354 are brought in close proximity to each other. However, these edges are slightly recessed with respect to the cutting edge 306 and outer annular edge 356, such that they do not cut through the layers of folded sheet with which they are in contact. Instead, the inner annular edge 308 of the upper die 304 and the inner annular edge 358 of the lower die 354 compress and fuse the layers of folded sheet between them together, and also bond the layers to the central core object 130 along its maximum diameter.

The upper and lower dies 304 and 354 may then be separated from each other by the actuator, and the die cut toroidal bladder removed from the dies 304 and 354. The die cut toroidal bladder may then have a valve (not shown) fitted to it, and be placed in a vulcanizing fixture (not shown) with a toroidal cavity having the desired final shape of the toroidal bladder. The toroidal bladder may be inflated to the toroidal shape of the cavity of the fixture, and vulcanized to form a finished transparent toroidal bladder 310 having a transparent outer wall and embedded central core object 130, as shown in FIG. 17.

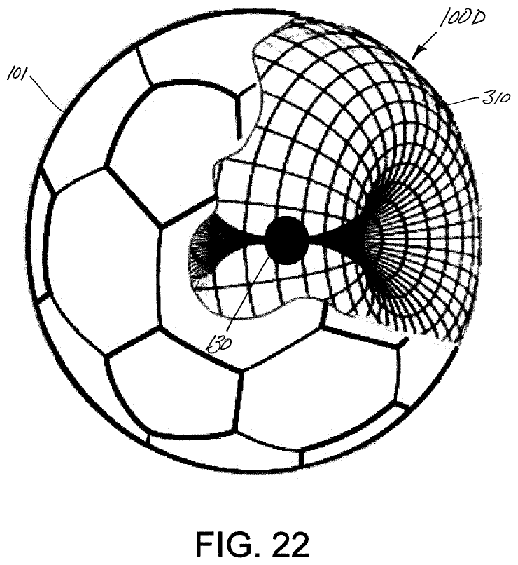

The finished transparent toroidal bladder 310 may then be fully inflated and disposed in a suitable transparent outer skin 101, at which time it conforms to the spherical shape of the outer skin 101, resulting in the sports ball 100C and 100D of FIGS. 21 and 22. The outer skin 101 may be formed by sewing as described previously, or by further vulcanizing. The transparent toroidal bladder 310 may be bonded to the inner surface of the outer skin 101 by adhesive, or by further vulcanizing. It is noted that the sports ball 100D of FIG. 22 is similar to the ball 100C of FIG. 21, but has a smaller center core 130, and a multifaceted outer skin 101 similar to a conventional soccer ball. It is further noted that the transparent toroidal bladder 310 is shown in a computer-generated mesh form, and the outer skin 101 is shown as though it is not transparent, for illustrative purposes.

The following materials may be used as transparent elastomeric materials that are suitable for forming the bladders and outer skins of the sports balls of the present disclosure. These materials are to be considered exemplary and not limiting. Other materials are contemplated. Center core objects are preferably made of lightweight materials such as hollow polymer forms, polymer foam, cork, or wood. Bladders and outer skins may be made of transparent latex, silicone, or polyurethane elastomer. Additionally, outer skins may be made of transparent polyvinyl chloride polymer. As used herein, “transparent” for the purposes of the balls of the present disclosure means sufficiently light transmissive such that the center core of a ball held within the bladder and outer skin is visible to an observer of the ball. The materials do not necessarily need to be optically as clear as common glass, and may have a hazy appearance from some light scattering, while still enabling the center core of a ball to be seen by an observer.

It is therefore apparent that there has been provided, in accordance with the present disclosure, a sports ball, and methods and apparatus for fabrication of the sports ball. The foregoing description of technology and the invention is merely exemplary in nature of the subject matter, manufacture, and use of the invention and is not intended to limit the scope, application, or uses of any specific invention claimed in this application or in such other applications as may be filed claiming priority to this application, or patents issuing therefrom. The following definitions and non-limiting guidelines must be considered in reviewing the description.

The description and specific examples, while indicating embodiments of the technology disclosed herein, are intended for purposes of illustration only and are not intended to limit the scope of the technology. Moreover, recitation of multiple embodiments having stated features is not intended to exclude other embodiments having additional features, or other embodiments incorporating different combinations of the stated features. Specific examples are provided for illustrative purposes of how to make and use the compositions and methods of this technology and, unless explicitly stated otherwise, are not intended to be a representation that given embodiments of this technology have, or have not, been made or tested.

To the extent employed herein, the words “preferred” and “preferably” refer to embodiments of the technology that afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the technology.

Unless otherwise specified, relational terms used in the present disclosure should be construed to include certain tolerances that those skilled in the art would recognize as providing equivalent functionality. By way of example, the term perpendicular is not necessarily limited to 90.00°, but also to any variation thereof that those skilled in the art would recognize as providing equivalent functionality for the purposes described for the relevant member or element. Terms such as “about” and “substantially” in the context of configuration relate generally to disposition, location, and/or configuration that is either exact or sufficiently close to the location, disposition, or configuration of the relevant element to preserve operability of the element within the invention while not materially modifying the invention. Similarly, unless specifically specified or clear from its context, numerical values should be construed to include certain tolerances that those skilled in the art would recognize as having negligible importance, as such do not materially change the operability of the invention.

As used herein, the words “comprise,” “include,” contain,” and variants thereof are intended to be non-limiting, such that recitation of items in a list is not to the exclusion of other like items that may also be useful in the materials, compositions, devices, and methods of this technology. Similarly, the terms “can” and “may” and their variants are intended to be non-limiting, such that recitation that an embodiment can or may comprise certain elements or features does not exclude other embodiments of the present technology that do not contain those elements or features.

Having thus described the basic concept of the invention, it will be apparent to those skilled in the art that the foregoing detailed disclosure is intended to be presented by way of example only, and is not limiting. Various alterations, improvements, and modifications will occur to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be expressly stated in the claims.

We claim:

1. A ball comprising a transparent outer wall surrounding a hollow cavity and defining a geometric center, and a central core object suspended at the geometric center of the hollow cavity.

2. The ball of claim 1, wherein the ball has the shape of a sphere having a center point, and the central core object is suspended at the center point of the sphere.

3. The ball of claim 2, wherein the central core object is spherical, and wherein the ratio of the diameter of the ball to the diameter of the central core object is between 2:1 and 20:1.

4. The ball of claim 1, wherein the ball has the shape of an ellipsoid sphere having a center point, and the central core object is suspended at central core object suspended at the center points of respective major and minor axes of the ellipsoid.

5. The ball of claim 1, wherein the transparent outer wall is elastically deformable.

6. The ball of claim 1, wherein the transparent outer wall of the ball is comprised of a transparent inflatable bladder contiguous with an inner surface of a transparent outer skin.

7. The ball of claim 6, wherein the transparent outer skin is comprised of a plurality of outer facets joined together.

8. The ball of claim 1, wherein the central core object is embedded at a center point of an elastic membrane joined to an interior surface of the transparent outer wall, the elastic membrane bisecting the hollow cavity of the ball into two equal volumes.

9. The ball of claim 1, wherein the central core object is suspended by a first elastic cord comprising a first end joined to the transparent outer wall, and a second end joined to the transparent outer wall and opposed to the first end.

10. The ball of claim 9, wherein the central core object is further suspended by a second elastic cord comprising a first end joined to the transparent outer wall, and a second end joined to the transparent outer wall and opposed to the first end, the second elastic cord aligned orthogonal to the first elastic cord.

11. The ball of claim 10, wherein the central core object is further suspended by a third elastic cord comprising a first end joined to the transparent outer wall, and a second end joined to the transparent outer wall and opposed to the first end, the third elastic cord aligned orthogonal to the first elastic cord and the second elastic cord.

12. The ball of claim 1, wherein the central core object is suspended by a first elastic cord comprising a first end joined to the transparent outer wall, and a second end joined to the central core object, a second elastic cord comprising a first end joined to the transparent outer wall, and a second end joined to the central core object, a third elastic cord comprising a first end joined to the transparent outer wall, and a second end joined to the central core object, and a fourth elastic cord comprising a first end joined to the transparent outer wall, and a second end joined to the central core object, the first, second, third, and fourth elastic cords operable to provide force vectors maintaining the central core object in position at the geometric center of the hollow cavity of the ball.

13. A ball comprising a transparent outer wall surrounding a hollow cavity and defining a geometric center, a transparent toroidal bladder contained within the transparent outer wall and having an outer wall portion contiguous with the transparent outer wall, and a central core object joined to a central wall portion of the transparent toroidal bladder, and suspended at the geometric center of the hollow cavity.
